(19) United States
(12) Patent Application Publication
(10) Pub. No.: US 2017/0202032 A1
(43) Pub. Date: Jul. 13, 2017

(54) Method, Apparatus and System for Processing Blind Detection Capability During Trunking Group Call

(71) Applicant: Beijing Xinwei Telecom Technology Inc., Beijing (CN)

(72) Inventors: Yuanchun Tan, Beijing (CN); Qian Li, Beijing (CN)

(73) Assignee: Beijing Xinwei Telecom Technology Inc., Beijing (CN)

(21) Appl. No.: 15/310,876

(22) PCT Filed: Dec. 9, 2014
(86) PCT No.: PCT/CN2014/093315

§ 371 Date: Nov. 14, 2016

(30) Foreign Application Priority Data
Dec. 9, 2013 (CN) 201310664570.6

(51) Int. Cl. H04W 76/00; H04W 74/08; H04W 72/12; H04W 74/00

(52) U.S. Cl. CPC H04W 76/002; H04W 74/004; H04W 74/0833; H04W 72/121

(57) ABSTRACT

The present disclosure provides a method for processing a blind detection capability during a trunking group call. According to the method, a terminal may report a trunking identifier and a physical downlink control channel (PDCCH) blind detection capability of the terminal to a base station when the terminal is in a radio resource control_connected (RRC_connected) state and is receiving a called party service of trunking group call.

### TECHNICAL FIELD

The present disclosure relates to wireless communication systems, and in particular to a method, apparatus and a system for processing a blind detection capability during a trunking group call.

### BACKGROUND

After a trunking function is added to LTE systems, a trunking service is provided to terminals. The identifier of the air interface corresponding to the trunking service is group-Radio Network Temporary Identity (G-RNTI). If the G-RNTI is placed in a UE-specific search space in a physical downlink control channel (PDCCH), blind detection of the G-RNTI is required in the terminal, i.e., the terminal is required to perform extra blind detection. A terminal only with blind detection capabilities required by regular LTE services cannot support the point-to-point service and the trunking service at the same time. If the G-RNTI is placed in a common search space in a PDCCH, the terminal does not need to perform extra blind detection. The protocol defines a total of 16 control channel elements (CCE) (from 0 to 15) in a PDCCH CCE common search space, and the CCEs are allocated in a granularity of 4 or 8 CCEs. Therefore, when there are a large amount of group call traffic in a cell, the approach of transmitting the G-RNTI in a common search space may be restricted by the common search space, that is, a lot of group calls may be unable to be scheduled timely because they are unable to obtain CCE resources for their G-RNTIs.

According to a conventional technical mechanism, if a user equipment (UE) receiving a group call in the current cell has a UE-specific service to be scheduled in a downlink transmit time interval (TTI), a sending terminal may transmit a G-RNTI or a semi-persistent scheduling (SPS) G-RNTI of the group call in a common search space, and transmit a cell-RNTI (C-RNTI) or a SPS C-RNTI of the UE-specific service in a UE-specific search space. If the group call in the current cell includes no UE-specific service to be scheduled in the downlink TTI, the sending terminal may schedule the group call by transmitting the G-RNTI or the SPS G-RNTI in a UE-specific search space.

### SUMMARY

The present disclosure provides a method for processing a blind detection capability during a trunking group call. The method may include:

reporting, by a terminal, a trunking identifier and a PDCCH blind detection capability of the terminal to a base station when the terminal is in a radio resource control_connected (RRC_connected) state and is receiving a called party service of trunking group call.

The present disclosure also provides a terminal for processing a blind detection capability during a trunking group call. The terminal may include:

an informing module, configured to report a trunking identifier and a PDCCH blind detection capability of the terminal to a base station when the terminal is in an RRC_connected state and is receiving a called party service of trunking group call.

The present disclosure also provides a method for processing a blind detection capability during a trunking group call. The method may include:

receiving, by a base station, a message sent by a terminal which is in an RRC_connected state and is receiving a trunking service, the message specifies a trunking identifier and a PDCCH blind detection capability of the terminal; and

determining the trunking service and the PDCCH blind detection capability of the terminal.

The present disclosure also provides a base station for processing a blind detection capability during a trunking group call. The base station may include:

a receiving module, configured to receive a message sent by a terminal which is in an RRC_connected state and is receiving a trunking service, the message specifies a trunking identifier and a PDCCH blind detection capability of the terminal; and

a first judging module, configured to determine the trunking service and the PDCCH blind detection capability of the terminal according to the message received by the receiving module.

### BRIEF DESCRIPTION OF THE DRAWINGS

FIG. 1 is a flowchart illustrating a method for processing a blind detection capability during a trunking group call performed at a terminal in accordance with an embodiment of the present disclosure;

FIG. 2 is a schematic diagram illustrating the structure of a conventional C-RNTI medium access control (MAC) control element (CE);

FIG. 3 is a schematic diagram illustrating the structure of a customized P-ability MAC CE;

FIG. 4 is a logical channel identifier (LCID) list of a conventional LTE uplink shared channel (UL-SCH);

FIG. 5 is a LCID list including a customized P-ability;

FIG. 6 is a flowchart illustrating a method for processing a blind detection capability during a trunking group call performed at a base station in accordance with another embodiment of the present disclosure;

FIG. 7 is a block diagram illustrating the structure of a terminal for processing a blind detection capability during a trunking group call in accordance with an embodiment of the present disclosure;

FIG. 8 is a block diagram illustrating the structure of a base station for processing a blind detection capability during a trunking group call in accordance with another embodiment of the present disclosure;

FIG. 9 is a block diagram illustrating the structure of a system for processing a blind detection capability during a trunking group call in accordance with another embodiment of the present disclosure;

FIG. 10 is a block diagram illustrating the hardware structure of a terminal for processing a blind detection capability during a trunking group call in accordance with an embodiment of the present disclosure;

FIG. 11 is a block diagram illustrating the hardware structure of a terminal for processing a blind detection capability during a trunking group call in accordance with another embodiment of the present disclosure.

### DETAILED DESCRIPTION

During the process of conceiving the present disclosure, the inventors found that the conventional mechanism may have the following drawback. A base station may make scheduling decisions without checking the PDCCH blind detection capability of each terminal in a group call. When all of terminals in a trunking group call support G-RNTI transmitted in a trunking service-specific search space, the base station may still schedule the trunking group call using a common search space, thereby the number of group calls may be restricted by the common search space.

It should be noted that various embodiments and technical features of various embodiments can be arbitrarily combined with each other as long as they do not conflict with each other. The present disclosure is described hereinafter with reference to the accompanying drawings and in combination with some examples.

For easy reference and for clarity, the following descriptions, abbreviations and acronyms of technical terms used herein are summarized below.

LTE: long term evolution system

G-RNTI: group-RNTI

CCE: control channel elements

C-RNTI: cell-RNTI

UE: user equipment

TTI: transmit time interval

PDCCH: physical downlink control channel

MAC: medium access control

RRC: radio resource control

SPS: semi-persistent scheduling

UL-SCH: uplink shared channel

LCID: logical channel identifier

PHR: power headroom report

BSR: buffer status report

In the following examples, the method of the present disclosure is described respectively from the perspective of a terminal and of a base station.

### Embodiment 1

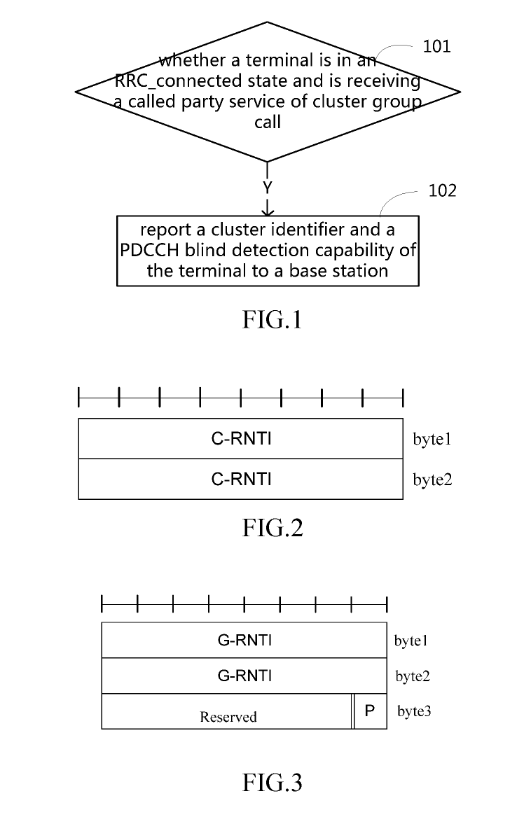

FIG. 1 is a flowchart of a method for processing a blind detection capability during a trunking group call performed at a terminal in accordance with an embodiment of the present disclosure. As shown in FIG. 1, the method may include the following procedures.

At block 101, a determination is made that a terminal is in an RRC_connected state and is receiving a called party service of trunking group call.

At block 102, when the terminal is in the RRC_connected state and is receiving a called party service of trunking group call, the terminal may report a trunking identifier and a PDCCH blind detection capability of the terminal to a base station.

In an example, the PDCCH blind detection capability of terminals may be divided into two levels, i.e., a high level and a low level. A terminal with the low PDCCH blind detection capability indicates that the terminal is capable of performing blind detection of C-RNTI in a UE-specific search space and blind detection of G-RNTI in a common search space at the same time within a TTI. A terminal with the high PDCCH blind detection capability indicates that the terminal is capable of performing blind detection of C-RNTI in a UE-specific search space and blind detection of G-RNTI in a UE-specific search space at the same time within a TTI, as shown in table 1 below.

TABLE 1
PDCCH blind detection capabilities of terminal
and corresponding meanings

| PDCCH blind detection | |
|---|---|
| capability of terminal | meaning |
| low | C-RNTI in a UE-specific search space + |
| | G-RNTI in a common search space |
| high | C-RNTI in a UE-specific search space + |
| | G-RNTI in a UE-specific search |
| | space |

If a terminal is not in the RRC_connected state with an ongoing called party service of trunking group call, or if the terminal is in an RRC_idle state, the terminal may not report the G-RNTI corresponding to the called party service of trunking group call to the base station.

In an example, when a terminal is in the RRC_idle state and is receiving a called party service of trunking group call and has the low PDCCH blind detection capability, the terminal may initiates a random access process to enter the RRC_connected state.

The trunking identifier and the PDCCH blind detection capability of the terminal may be reported according to, but not limited to, the following two manners.

According to a first manner, the trunking identifier of the terminal may be reported to the base station through a C-RNTI MAC CE.

Specifically, if the terminal has a low blind detection capability, the terminal may report the G-RNTI to the base station through a C-RNTI MAC CE; if the terminal has a high blind detection capability, the terminal may not report the G-RNTI to the base station through a C-RNTI MAC CE.

In this example, the structure of the C-RNTI MAC CE may be as shown in FIG. 2. In the C-RNTI MAC CE, the C-RNTI may occupy 16 bits.

According to a second manner, the trunking identifier and the PDCCH blind detection capability of the terminal may be reported to the base station through a PDCCH blind detection capability (P-ability) MAC CE.

In this example, the structure of the P-ability MAC CE may be as shown in FIG. 3. In the P-ability MAC CE, the G-RNTI may occupy 16 bits. The PDCCH blind detection capability is specified in the P field which may occupy one bit. For example, a low PDCCH blind detection capability may be denoted by “1”, and a high PDCCH blind detection capability may be denoted by “0”. The remaining 7 bits are reserved. Of course, the structure of the P-ability MAC CE may not be limited to this example.

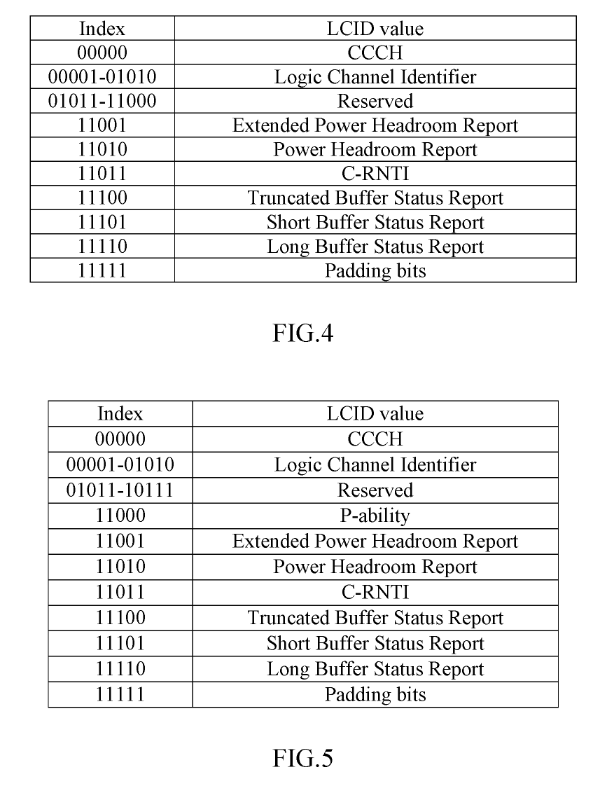

An LCID list of a conventional LTE UL-SCH channel is as shown in FIG. 4. FIG. 5 illustrates an LCID list including a customized P-ability. As shown in FIG. 5, when and LCID corresponding to an index of 11000 may be the P-ability.

The above two manners are merely examples, not for limiting the present disclosure. Other manners may also be used in various embodiments.

### Embodiment 2

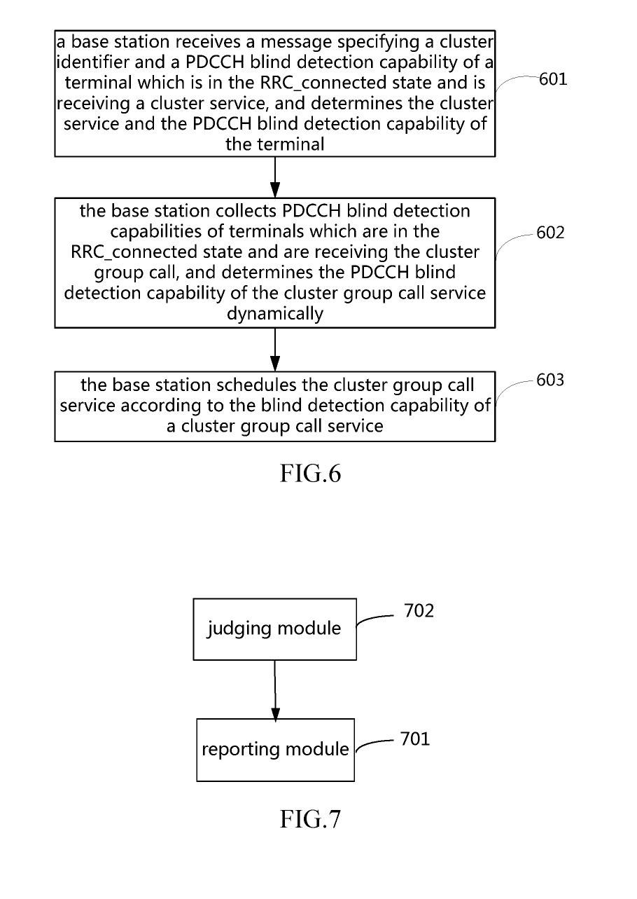

Corresponding to the above example, FIG. 6 illustrates a method performed by a base station according to the present disclosure. The method may include the following procedures.

At block 601, a base station may receive a message specifying a trunking identifier and a PDCCH blind detection capability of a terminal which is in an RRC_connected state and is receiving a trunking service, and determine the trunking service and PDCCH blind detection capability of the terminal.

Corresponding to the two manners for the terminal in the above embodiment, the base station may act as follows.

### Manner 1:

A cell of the base station may receive a C-RNTI MAC CE reported by a terminal, and obtain the value of a C-RNTI field in the C-RNTI MAC CE. The value may be denoted by G. The cell may judge whether G is the same with the C-RNTI of the terminal, determine that the terminal is receiving a called party service of trunking group call whose G-RNTI is G and that the terminal has a low PDCCH blind detection capability in response to a determining that G is different from the C-RNTI of the terminal.

### Manner 2:

A cell of a base station may receive a P-ability MAC CE reported by a terminal, and obtain the value of a G-RNTI field and the value of a P field in the P-ability MAC CE. The value of the G-RNTI field may be denoted by G, and the value of the P field may be denoted by D. The cell may determine the terminal is receiving a called party service in a trunking group call whose G-RNTI is G, and make a judgment according to D. For example, when D is 1, the cell may determine the terminal has a low PDCCH blind detection capability; when D is 0, the cell may determine the terminal has a high PDCCH blind detection capability. Of course, the present disclosure is not limited to this example. The content of the P field may be designed according to the practical situations of the system, and is not limited to the high level and the low level of this example.

At block 602, the base station may obtain the PDCCH blind detection capability of each terminal that is in the RRC_connected state and is receiving the trunking group call, and determine the PDCCH blind detection capability of the trunking service dynamically.

Specifically, when all of PDCCH blind detection capabilities collected by the cell of the base station from terminals which are in the RRC_connected state and are receiving the trunking group call are high, the cell may determine the PDCCH blind detection capability of the trunking group call is high; when not all of PDCCH blind detection capabilities collected by the cell from terminals in the RRC_connected state in the trunking group call are high, the cell may determine the PDCCH blind detection capability of the trunking group call is low.

The dynamically determining procedure may include determining a blind detection capability of a trunking group call, or updating a blind detection capability of a trunking group call.

At block 603, the base station may schedule the trunking group call according to the blind detection capability of the trunking group call.

Specifically, when the blind detection capability of a trunking group call is determined to be high, the G-RNTI corresponding to the trunking group call service may be scheduled in a UE-specific search space. When the blind detection capability of a trunking group call is determined to be low, the G-RNTI corresponding to the trunking group call may be scheduled in a common search space.

In an example, a base station may determine the PDCCH blind detection capabilities of all terminals (including terminals in the RRC_connected state and terminals in the RRC_idle state) in the trunking group call to be high by default during an initialization process.

According to the method of various examples of the present disclosure, a base station may adjust the type of space allocated for the G-RNTI corresponding to a group call reasonably according to PDCCH blind detection capabilities of terminals participating in the trunking group call to maximize the system capacity of group call.

The above method embodiments of the present disclosure are described in the following two examples.

### Example 1

In an example, there may be three UEs in a cell of a base station, denoted by UE0˜UE2 respectively, and there may be a trunking called party service whose G-RNTI is 15 in the cell. UE0˜UE2 are receiving the trunking called party service. UE0 and UE1 are in the RRC_connected state, and UE2 is in the RRC_idle state. C-RNTI of UE0 is 5, and C-RNTI of UE1 is 23. UE0 has a low PDCCH blind detection capability, and both UE1 and UE2 have a high PDCCH blind detection capability. The terminals may perform feedback through C-RNTI MAC CEs, and the base station may perform receiving and processing correspondingly.

At sending end:

At UE0:

The terminal UE0 is in the RRC_connected state and is receiving a called party service of trunking group call whose G-RNTI is 15. UE0 has the low PDCCH blind detection capability. UE0 may report to the trunking group call identifier of UE0 to the cell of the base station through a C-RNTI MAC CE. In an example, the UE0 may load the G-RNTI, i.e., 15, into the C-RNTI MAC CE, and transmit the C-RNTI MAC CE to the cell.

At UE1:

The terminal UE1 is in the RRC_connected state and is receiving a called party service of trunking group call whose the G-RNTI is 15. UE1 has the high PDCCH blind detection capability. UE1 may not report the trunking group call identifier of UE1 to the cell of the base station through a C-RNTI MAC CE.

At UE2:

The terminal UE2 is in the RRC_idle state, and has the high blind detection capability. Therefore, UE2 may not report the trunking group call identifier of UE2 to the cell of the base station through a C-RNTI MAC CE.

If UE2 has the low blind detection capability, UE2 may initiate a random access process to enter the RRC_connected state to report the trunking group call identifier of UE2.

At receiving end: At the cell of the base station

The cell of the base station may receive the C-RNTI MAC CE reported by UE0, obtain that the value of the C-RNTI field is 15, and compare the value of the C-RNTI field with 5 which is the C-RNTI of UE0. If two values are different, the cell may determine that the terminal is receiving a called party service of trunking group call whose C-RNTI is 5 and that the terminal has the low PDCCH blind detection capability.

If C-RNTI MAC CEs fed back by the other terminals receiving the called party service of trunking group call whose C-RNTI is 5 are not received by the cell, the cell may determine the other terminals have the high PDCCH blind detection capability by default.

Accordingly, if UE2 has the low blind detection capability, UE2 may initiate a random access process to enter the RRC_connected state to report the trunking group call identifier of UE2. In this case, the cell may receive the information reported by UE2.

In an example, the cell of the base station may collect blind detection capabilities of the terminals which are in the RRC_connected state in the trunking group call, and determine or update the blind detection capability of the trunking group call. Specifically, the cell may determine the blind detection capability of the trunking group call whose G-RNTI is 15 is low after determining that UE0 is a terminal which is in the RRC_connected state and is receiving the called party service of the trunking group call and that UE0 has the low blind detection capability.

In an example, the cell of the base station may schedule the trunking group call according to the blind detection capability of the trunking group call. Specifically, in response to a determination that the blind detection capability of the trunking group call is low, the cell may schedule the G-RNTI corresponding to the trunking group call in a common search space.

### Example 2

In an example, there may be four UEs in a cell of a base station, denoted by UE0˜UE3 respectively, and there may be a trunking called party service whose G-RNTI is 31 in the cell. UEs receiving the trunking called party service are UE0˜UE3. UE1, UE2 and UE3 are in the RRC_connected state, and UE0 is in the RRC_idle state. The C-RNTI of UE1 may be 16, the C-RNTI of UE2 may be 24, and the C-RNTI of UE3 may be 35. UE0˜UE3 all have the high PDCCH blind detection capability. The terminals may feed back using the second manner (i.e. using a P-ability MAC CE), and the base station may performs receiving and processing according to the manner 2.

At sending end:

At UE0:

Terminal UE0 is in the RRC_idle state, and may not report the trunking group call identifier and the PDCCH blind detection capability of UE0 to the cell of the base station through a P-ability MAC CE.

At UE1:

Terminal UE1 is in the RRC_connected state and is receiving a called party service of the trunking group call whose the G-RNTI is 31. UE1 has the high PDCCH blind detection capability, and may report the trunking group call identifier and the PDCCH blind detection capability of UE1 to the cell of the base station through a P-ability MAC CE. The values of the fields of the P-ability MAC CE may be: the value of the G-RNTI field is 31, the value of the P field is 0, and the value of the Reserved field is a random value.

At UE2:

Terminal UE2 is in the RRC_connected state and is receiving a called party service of the trunking group call whose G-RNTI is 31. UE2 has a high PDCCH blind detection capability, and may report the trunking group call identifier and the PDCCH blind detection capability of UE2 to the cell of the base station through a P-ability MAC CE. The values of the fields in the P-ability MAC CE may be: the value of the G-RNTI field is 31, the value of the P field is 0, and the value of the Reserved field is a random value.

At UE3:

Terminal UE3 is in the RRC_connected state and is receiving a called party service of the trunking group call whose G-RNTI is 31. UE3 has the high PDCCH blind detection capability, and may report the trunking group call identifier and the PDCCH blind detection capability of UE3 to the cell of the base station through a P-ability MAC CE. The values of the fields in P-ability MAC CE may be: the value of the G-RNTI field is 31, the value of the P field is 0, and the value of the Reserved field is a random value.

At receiving end: at the cell of the base station

The cell of the base station may receive the P-ability MAC CE reported by UE1, obtain that the value of the C-RNTI field is 31 and that the value of the P field is 0, and determine that UE1 is receiving a called party service of the trunking group call whose C-RNTI is 31 and that UE1 has the high PDCCH blind detection capability.

The cell of the base station may receive the P-ability MAC CE reported by UE2, obtain that the value of the C-RNTI field is 31 and the value of the P field is 0, and determine that UE2 is receiving a called party service of the trunking group call whose C-RNTI is 31 and that UE2 has the high PDCCH blind detection capability.

The cell of the base station may receive the P-ability MAC CE reported by UE3, obtain that the value of the C-RNTI field is 31 and the value of the P field is 0, and determine that UE3 is receiving a called party service of the trunking group call whose C-RNTI is 31 and that UE3 has the high PDCCH blind detection capability.

In an example, the cell of the base station may collect the blind detection capabilities of terminals in the RRC_connected state in the trunking group call, and determine or update the blind detection capability of the trunking group call. Specifically, the cell of the base station may obtain that UE1, UE2 and UE3 are terminals which are in the RRC_connected state and are receiving a called party service in the trunking group call whose C-RNTI is 31 and that all of UE1, UE2 and UE3 have the high blind detection capability, the cell may determine the blind detection capability of the trunking group call is high.

In an example, the cell of the base station may schedule the trunking group call according to the blind detection capability of the trunking group call. Specifically, when the blind detection capability of the trunking group call is judged to be high, the cell may schedule the G-RNTI corresponding to the trunking group call in a UE-specific search space.

### Embodiment 3

Embodiment 3 of the present disclosure provides a terminal for processing a blind detection capability during a trunking group call. As shown in FIG. 7, the terminal may include a reporting module 701. The reporting module 701 may report a trunking identifier and a PDCCH blind detection capability of the terminal to a base station when the terminal is in an RRC_connected state and is receiving a called party service of trunking group call.

In an example, the indicating module may not report the trunking identifier and the PDCCH blind detection capability of the terminal to the base station either when the terminal is in the RRC_connected state and is not receiving the called party service of trunking group call or when the terminal is in an RRC_idle state.

In an example, the terminal may also include a judging module 702. The judging module 702 may record that the terminal has a low level of blind detection capability when the terminal is capable of performing blind detection of a C-RNTI in a UE-specific search space and blind detection of a G-RNTI in a common search space at the same time within a TTI; and record that the terminal has a high level of blind detection capability when the terminal is capable of performing blind detection of a C-RNTI in a UE-specific search space and blind detection of a G-RNTI in a UE-specific search space at the same time within a TTI.

In an example, when the terminal is in an RRC_idle state and is receiving a called party service of trunking group call and has a low level of PDCCH blind detection capability, the terminal may initiate a random access process to enter the RRC_connected state.

In an example, the reporting module may report the trunking identifier of the terminal to the base station when the judging module records that the terminal has the low level of blind detection capability. The reporting module may not report the trunking identifier of the terminal to the base station when the judging module records that the terminal has the high level of blind detection capability.

In an example, the trunking identifier and the PDCCH blind detection capability of the terminal may be reported to the base station through a C-RNTI MAC CE or a P-ability MAC CE.

### Embodiment 4

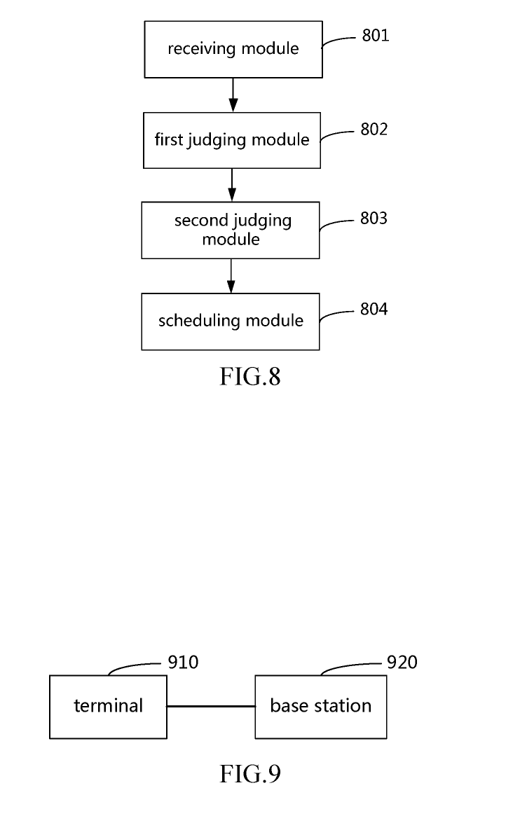

Embodiment 4 of the present disclosure provides a base station for processing a blind detection capability during a trunking group call. As shown in FIG. 8, the base station may include a receiving module 801 and a first judging module 802.

The receiving module 801 may receive a message reported by a terminal which is in an RRC_connected state and is receiving a trunking service. The message specifies a trunking identifier and a PDCCH blind detection capability of the terminal.

The first judging module 802 may determine the trunking service and the PDCCH blind detection capability of the terminal according to the message received by the receiving module 801.

In an example, the first judging module may compare the value of a C-RNTI obtained from a C-RNTI MAC CE reported by the terminal with a C-RNTI corresponding to the terminal after the receiving module receives the C-RNTI MAC CE, and determine that the terminal is receiving a trunking service corresponding to the obtained value of the C-RNTI obtained from the C-RNTI MAC CE in response to a determination that the two values are different and that the terminal has a low level of PDCCH blind detection capability.

In an example, the first judging module may also obtain the value of a G-RNTI of the trunking service and the value of the PDCCH blind detection capability of the terminal after the receiving module receives a P-ability MAC CE reported by a terminal, determine that the terminal is receiving a trunking service corresponding to the G-RNTI and that the terminal has a PDCCH blind detection capability identified by the value of the PDCCH blind detection capability.

In an example, the base station may also include a second judging module 803. The second judging module 803 may collect blind detection capabilities of terminals which are in the RRC_connected state and are receiving the trunking service, and determine the blind detection capability of the trunking service dynamically.

The second judging module may determine the blind detection capability of the trunking service is high when the PDCCH blind detection capabilities collected from the terminals in the RRC_connected state in the trunking service are all high, and determine the blind detection capability of the trunking service is low when not all the PDCCH blind detection capabilities collected from the terminals in the RRC_connected state in the trunking service are high.

In an example, the base station may also include a scheduling module 804. The scheduling module 804 may schedule the trunking service according to the blind detection capability of the trunking service.

When the PDCCH blind detection capability of the trunking service is high, the scheduling module may schedule the trunking service by transmitting the G-RNTI in a UE-specific search space; when the PDCCH blind detection capability in the trunking service is low, the scheduling module may schedule the trunking service by transmitting the G-RNTI in a common search space.

In an example, the first judging module may determine blind detection capabilities of all of the terminals are high by default during an initialization process.

### Embodiment 5

The present disclosure also provides a system for processing a blind detection capability during a trunking group call. As shown in FIG. 9, the system may include the terminal 901 as described in Embodiment 3 and the base station 920 as described in Embodiment 4.

### Embodiment 6

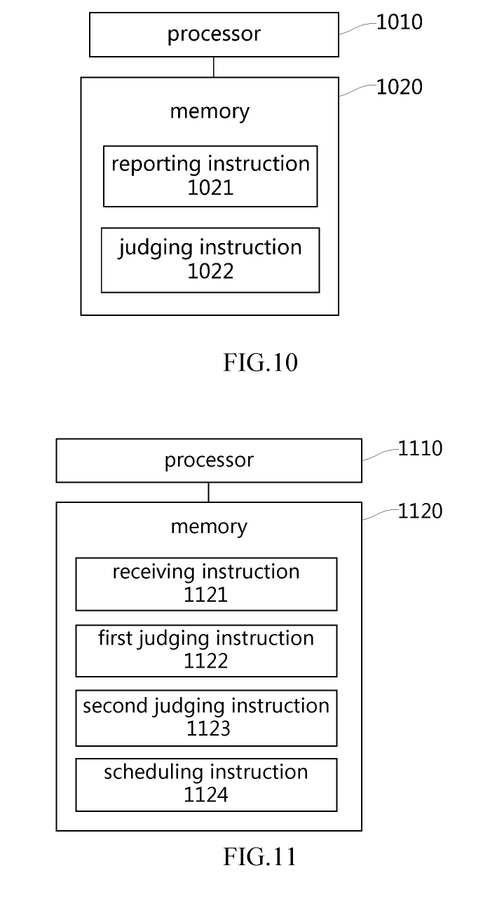

FIG. 10 is a block diagram illustrating the hardware structure of a terminal for processing a blind detection capability during a trunking group call in an embodiment of the present disclosure. As shown in FIG. 10, the hardware may include at least one processor 1010, a memory 1020, and at least one instruction stored in the memory 1020. The instruction is executable by the processor 1010. For example, the instruction may include instructions for implementing the steps of the method embodiments, i.e. a reporting instruction 1021 and a judging instruction 1022. The detailed process may be similar to the terminal-implemented method described in Embodiment 1 or similar to the process performed at the terminal described in Embodiment 3.

### Embodiment 7

FIG. 11 is a block diagram illustrating the hardware structure of a base station for processing a blind detection capability during a trunking group call in another embodiment of the present disclosure. As shown in FIG. 11, the hardware may include at least one processor 1110, a memory 1120, and at least one instruction stored in the memory 1120. The instruction is executable by the processor 1110. For example, the instruction may include instructions for implementing the steps of the method embodiments, i.e. a receiving instruction 1121 and a first judging instruction 1122, a second judging instruction 1123 and a scheduling instruction 1124. The detailed process may be similar to the base station-implemented method as described in Embodiment 2 or similar to the process performed at a base station described in Embodiment 4.

As can be seen from the above embodiments, according to the methods, apparatuses, systems and hardware for processing a blind detection capability during a trunking group call provided by the present disclosure, a base station can adjust the type of space allocated for G-RNTI corresponding to a group call reasonably according to PDCCH blind detection capabilities of terminals receiving a trunking service, so that the system capacity of group call can be maximized.

What is described in the foregoing are only embodiments of the present disclosure, and should not be construed as limitations to the present disclosure. Any changes, equivalent replacements, modifications made without departing from the scope and spirit of the present disclosure are intended to be included within the protecting scope of the present disclosure.

1. A method for processing a blind detection capability during a trunking group call, comprising:
reporting, by a terminal, a trunking identifier and a physical downlink control channel (PDCCH) blind detection capability of the terminal to a base station when the terminal is in a radio resource control_connected (RRC_connected) state and is receiving a called party service of trunking group call.

2. The method of claim 1, further comprising: skipping, by the terminal, the step of reporting the trunking identifier and the PDCCH blind detection capability of the terminal to the base station either when the terminal is in the RRC_connected state and is not receiving the called party service of trunking group call or when the terminal is in an RRC_idle state.

3. The method of claim 1, wherein reporting by the terminal the trunking identifier and the PDCCH blind detection capability of the terminal to the base station comprises: reporting, by the terminal, the trunking identifier to the base station when the PDCCH blind detection capability of the terminal is low; and skipping, by the terminal, the step of reporting the trunking identifier to the base station when the PDCCH blind detection capability of the terminal is not low.

4. The method of claim 3, wherein the trunking identifier reported by the terminal to the base station is transmitted in a cell-radio network temporary identifier (C-RNTI) medium access control (MAC) channel element (CE).

5. The method of claim 1, wherein the trunking identifier and the PDCCH blind detection capability reported by the terminal to a base station are transmitted in a PDCCH blind detection capability (P-ability) medium access control (MAC) channel element (CE).

6. The method of claim 5, wherein the P-ability MAC CE comprises a predetermined field for specifying the PDCCH blind detection capability.

7. The method of claim 1, wherein the PDCCH blind detection capability of the terminal is low indicates the terminal is capable of performing blind detection of a C-RNTI in a UE-specific search space and blind detection of a group-RNTI (G-RNTI) in a common search space at the same time within a transmit time interval (TTI); the PDCCH blind detection capability of the terminal is high indicates the terminal is capable of performing blind detection of a C-RNTI in a UE-specific search space and blind detection of a G-RNTI in a UE-specific search space at the same time within a TTI.

8. The method of claim 1, further comprising: initiating, by the terminal, a random access process to enter the RRC_connected state when the terminal is in an RRC_idle state and is receiving the called party service of trunking group call and the PDCCH blind detection capability of the terminal is low.

9.-15. (canceled)

16. A method for processing a blind detection capability during a trunking group call, comprising:
receiving, by a base station, a message reported by a terminal which is in a radio resource control_connected (RRC_connected) state and is receiving a trunking service, wherein the message specifies a trunking identifier and a physical downlink control channel (PDCCH) blind detection capability of the terminal; and
determining the trunking service and the PDCCH blind detection capability of the terminal.

17. The method of claim 16, wherein determining the trunking service and the PDCCH blind detection capability of the terminal comprises: obtaining a value of a cell-radio network temporary identifier (C-RNTI) from a C-RNTI medium access control (MAC) channel element (CE) reported by the terminal and comparing the value of the C-RNTI obtained from the C-RNTI MAC CE with a C-RNTI corresponding to the terminal after receiving the C-RNTI MAC CE), and determining that the terminal is receiving a trunking service identified by the value of the C-RNTI obtained from the C-RNTI MAC CE and that the PDCCH blind detection capability of the terminal is low in response to a determination that the value of the C-RNTI obtained from the C-RNTI MAC CE is different from the C-RNTI corresponding to the terminal.

18. The method of claim 16, wherein determining the trunking service and the PDCCH blind detection capability of the terminal comprises: obtaining a value of a group-RNTI (G-RNTI) and a value of a PDCCH blind detection capability of the terminal from a PDCCH blind detection capability (P-ability) medium access control (MAC) channel element (CE) reported by the terminal after receiving the P-ability MAC CE, and determining that the terminal is receiving a trunking service identified by the value of the G-RNTI and that the terminal has a PDCCH blind detection capability identified by the value of the PDCCH blind detection capability.

19. The method of claim 16, further comprising: collecting, by the base station, PDCCH blind detection capabilities of terminals which are in the RRC_connected state and are receiving the trunking service, and determining a PDCCH blind detection capability of the trunking service dynamically.

20. The method of claim 19, wherein determining the PDCCH blind detection capability of the trunking service dynamically comprises: determining the PDCCH blind detection capability of the trunking service is high in response to a determination that the PDCCH blind detection capabilities collected from the terminals which are in the RRC_connected state and are receiving the trunking service are all high, and determining the PDCCH blind detection capability of the trunking service is low in response to a determination that not all the PDCCH blind detection capabilities collected from the terminals are high.

21. The method of claim 19, further comprising: scheduling, by the base station, the trunking service according to the PDCCH blind detection capability of the trunking service.

22. The method of claim 21, wherein scheduling by the base station the trunking service according to the PDCCH blind detection capability of the trunking service comprises: scheduling, by the base station, the trunking service by transmitting a G-RNTI corresponding to the trunking service in a UE-specific search space when the PDCCH blind detection capability of the trunking service is high; scheduling, by the base station, the trunking service by transmitting the G-RNTI corresponding to the trunking service in a common search space when the PDCCH blind detection capability of the trunking service is low.

23.-32. (canceled)

33. A terminal for processing a blind detection capability during a trunking group call, comprising a processor and a memory storing computer-readable instructions executable by the processor to:
report a trunking identifier and a physical downlink control channel (PDCCH) blind detection capability of the terminal to a base station when the terminal is in a radio resource control_connected (RRC_connected) state and is receiving a called party service of trunking group call.

34. The terminal of claim 33, wherein the instructions are executable by the processor to:
skip the step of reporting the trunking identifier and the PDCCH blind detection capability of the terminal to the base station either when the terminal is in the RRC_connected state and is not receiving the called party service of trunking group call or when the terminal is in an RRC_idle state.

35. The terminal of claim 33, wherein the instructions are executable by the processor to:
report the trunking identifier to the base station when the PDCCH blind detection capability of the terminal is low; and skip the step of reporting the trunking identifier to the base station when the PDCCH blind detection capability of the terminal is not low.

36. The terminal of claim 33, wherein the trunking identifier and the PDCCH blind detection capability reported by the terminal to a base station are transmitted in a PDCCH blind detection capability (P-ability) medium access control (MAC) channel element (CE) or in a cell-radio network temporary identifier (C-RNTI) medium access control (MAC) channel element (CE).

37. The terminal of claim 33, wherein the PDCCH blind detection capability of the terminal is low indicates the terminal is capable of performing blind detection of a C-RNTI in a UE-specific search space and blind detection of a group-RNTI (G-RNTI) in a common search space at the same time within a transmit time interval (TTI); the PDCCH blind detection capability of the terminal is high indicates the terminal is capable of performing blind detection of a C-RNTI in a UE-specific search space and blind detection of a G-RNTI in a UE-specific search space at the same time within a TTI.
